(19) United States
(12) Patent Application Publication
(10) Pub. No.: US 2026/0032212 A1
(43) Pub. Date: Jan. 29, 2026

(54) INKJET PRINTING APPARATUS AND INFORMATION PROCESSING METHOD

(71) Applicant: CANON KABUSHIKI KAISHA, Tokyo (JP)

(72) Inventors: NOBORU KUNIMINE, Tokyo (JP); TAKAAKI SHIMA, Tokyo (JP); KAZUKI NARUMI, Tokyo (JP)

(21) Appl. No.: 19/282,495

(22) Filed: Jul. 28, 2025

(30) Foreign Application Priority Data
Jul. 29, 2024 (JP) 2024-122550

(51) Int. Cl. H04N 1/62; B41J 2/21; B41J 11/00; C09D 11/40; C09D 11/54; G06K 15/10

(52) U.S. Cl. CPC H04N 1/62; B41J 2/2103; B41J 2/2117; B41J 11/008; C09D 11/40; C09D 11/54; G06K 15/102

(57) ABSTRACT

An apparatus comprises: a printing unit configured to print an image on a print medium by applying a first ink, a second ink, a first reactive liquid, and a second reactive liquid; a generation unit configured to generate first print data by the first ink based on first image data, and generate second print data by the second ink based on second image data; a determination unit configured to determine application amounts of the first ink, the second ink, the first reactive liquid, and the second reactive liquid based on the first print data and the second print data; a conveyance unit configured to convey the print medium; and a control unit configured to control the printing unit to drive the printing unit in synchronization with conveyance by the conveyance unit based on the determined application amounts.

### BACKGROUND

### Field of the Technology

The present disclosure relates to a printing apparatus that discharges ink to form an image.

### Description of the Related Art

There is known an inkjet printing apparatus that uses color ink and a reactive liquid, and mixes them on a print medium to coagulate a color material in the color ink, thereby forming an image. Japanese Patent Laid-Open No. 2019-156995 discloses a technique of printing a stacked image formed from a white ink layer and a color ink layer on a nonabsorbable transparent print medium while applying white ink and color ink to the print medium together with a reactive liquid. Japanese Patent Laid-Open No. 2019-156995 describes an image printing method for obtaining a printed product excellent in image quality characteristics such as text sharpness by using one type of reactive liquid and controlling the coagulation of color ink and the coagulation of white ink with respect to the reactive liquid.

However, the print image quality may change in an image having a stacking area where ink layers of color ink, white ink, and the like are stacked on a print medium such as a transparent film. For example, the coagulation of a color material differs between a stacking area and a non-stacking area, and the degrees of scratch resistance, bleeding (ink flow), burying (degradation of color development by sedimentation of a color material), and the like change.

### SUMMARY

The present disclosure provides a technique capable of high-quality image printing.

According to one aspect of the present disclosure, an inkjet printing apparatus comprises: a printing unit configured to print an image on a print medium, the printing unit is configured to apply a first ink containing a color material, a second ink containing a color material of a type different from the first ink, a first reactive liquid that coagulates a color material in ink, and a second reactive liquid different from the first reactive liquid; a generation unit configured to generate first print data by the first ink based on first image data, and generate second print data by the second ink based on second image data different from the first image data; a determination unit configured to determine application amounts of the first ink, the second ink, the first reactive liquid, and the second reactive liquid for each partial area of the print medium based on the first print data and the second print data; a conveyance unit configured to convey the print medium; and a control unit configured to control the printing unit to drive the printing unit in synchronization with conveyance by the conveyance unit based on the application amounts determined by the determination unit, wherein the determination unit determines the application amounts of the first reactive liquid and the second reactive liquid by a first determination method for a stacking area where a print image by the first ink and a print image by the second ink are stacked, and determines the application amounts of the first reactive liquid and the second reactive liquid by a second determination method different from the first determination method for a non-stacking area where the print image by the first ink and the print image by the second ink are not stacked.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIGS. 1A and 1B are views showing the configuration of an inkjet printing apparatus;

FIG. 2 is a schematic view showing a printing control system;

FIG. 3 is a schematic view of an orifice forming substrate when viewed from the orifice surface;

FIGS. 4A to 4C are schematic views of a printhead when viewed from the orifice surface;

FIG. 5 is a view for explaining general print data generation;

FIG. 6 is a view for explaining a general multi-pass printing method;

FIG. 7 is a schematic view showing the sections of a stacking area and non-stacking area;

FIG. 8 is a view showing an example of pass masks;

FIG. 9 is a flowchart showing image processing;

FIG. 10 is a graph showing the relationship between the ink print amount and the reactive liquid print amount;

FIG. 11 is a view showing precipitates generated on the image surface;

FIGS. 12A to 12D are views for explaining pass masks;

FIG. 13 is a view showing an example of an input image;

FIG. 14 is a flowchart showing image processing (second embodiment); and

FIG. 15 is a flowchart showing image processing (third embodiment).

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

As the first embodiment of a printing apparatus according to the present disclosure, a printing apparatus using an inkjet printing method will be exemplified below. The printing apparatus may be a single-function printer having only a print function, or a multi-function printer having a plurality of functions such as a print function, a FAX function, and a scanner function.

In the following description, “print” means the formation of images such as characters and graphics on a print medium such as paper. Note that “print” includes the formation of images, figures, patterns, and the like on a print medium, or the processing of the medium, regardless of whether formed images are so visualized as to be visually perceivable by humans.

Also, a “print medium” includes not only paper used in common printing apparatuses, but also materials capable of accepting ink such as cloth, a plastic film, a metal plate, glass, ceramics, a resin, wood, and leather. Examples of a nonabsorbable print medium are glass, plastic, a film, and YUPO fabricated not as print media for water-based inkjet ink. Other examples are print media not surface-treated (that is, no ink absorption layer is formed) for inkjet printing, such as a plastic film, and a plastic-coated base such as paper. Examples of plastic are polyvinyl chloride, polyethylene terephthalate, polycarbonate, polystyrene, polyurethane, polyethylene, and polypropylene. An example of a low-absorbable print medium is actual printing stock used in offset printing or the like, such as art paper or coated paper.

### <Apparatus Configuration>

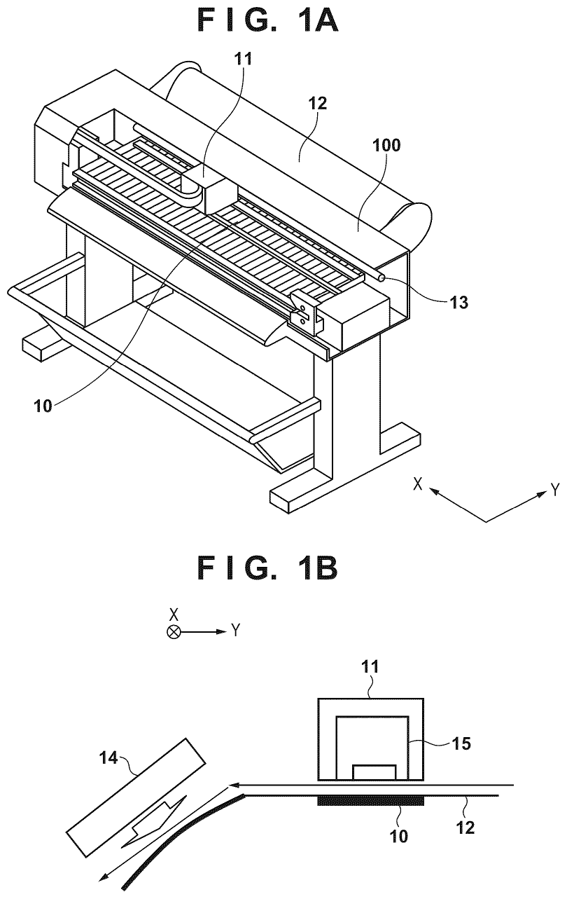

FIGS. 1A and 1B are views showing the configuration of an inkjet printing apparatus 100. FIG. 1A is a partially exploded perspective view for explaining the internal mechanism, and FIG. 1B is a sectional view. As shown in FIG. 1B, a print medium 12 is conveyed in the −Y direction in FIG. 1B along with driving of a sub-scanning motor (not shown). A guide shaft 13 is arranged to extend in the X direction crossing the Y direction serving as the conveyance direction of the print medium 12.

While supported by the guide shaft 13, a carriage 11 on which a printhead 15 arranged to face a platen 10 is mounted reciprocates (reciprocally scans) in the X direction by driving of a main scanning motor (not shown). During moving scanning of the carriage 11, the printhead 15 mounted on the carriage 11 discharges ink to the print medium 12 in accordance with print data, thereby printing on the print medium 12.

The inkjet printing apparatus 100 according to this embodiment adopts a so-called bidirectional printing method of printing an image on a print medium by discharging ink in both a case where the printhead 15 moves along the forward path and a case where it moves along the return path. When scanning accompanied by one printing by the printhead 15 is performed, the print medium 12 is conveyed by a predetermined amount by the sub-scanning motor (not shown).

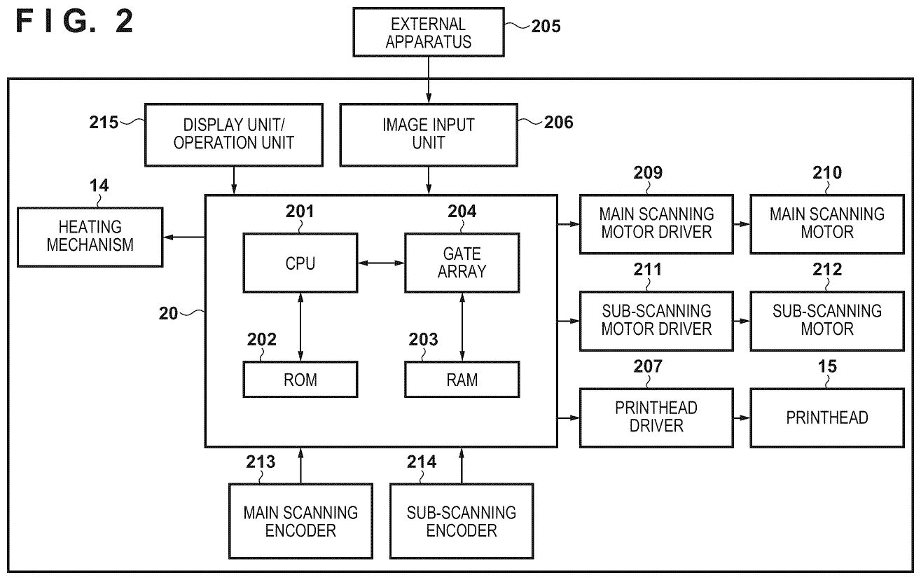

When a print operation command is input from an external apparatus 205 to be described later with reference to FIG. 2, the print medium 12 is fed to a position where the printhead 15 mounted on the carriage 11 can print. Then, main scanning of the printhead 15 while discharging ink in accordance with a print signal, and conveyance of the print medium 12 by a predetermined amount are alternately repeated, to print an image. That is, an image is printed in a predetermined area of the print medium 12 by changing the relative positions of the printhead 15 and print medium 12. The image formed on the print medium 12 on the platen 10 is conveyed in the −Y direction, and exposed to hot air by a heating mechanism 14 to heat the print medium to about 100° C., thereby heating and fixing the image.

The heating mechanism 14 also has a function of heating water-soluble resin particles (to be described later) to form a film in the printing apparatus. The water-soluble resin particles are a resin that forms a film by heating when applied onto a print medium, in order to improve the scratch resistance of an image. In this embodiment, the temperature setting is adjusted to be 80° C. on a print medium.

In this embodiment, the printhead 15 serving as a printing portion is configured to discharge color inks K, C, M, and Y and a white ink W. In addition, the printhead 15 is configured to discharge two types of reactive liquids RCT1 and RCT2. The reactive liquid contains a reactant, and reacts with solid contents such as a color material and resin particles contained in each ink to promote the coagulation. Details of the inks and reactive liquids will be described later.

FIG. 2 is a schematic view showing a printing control system. A control unit 20 in the inkjet printing apparatus 100 includes a CPU 201, a ROM 202, a RAM 203, and a gate array 204. An image input unit 206 is used to input image data from the external apparatus 205. The ROM 202 is a memory that stores programs for control of the printing apparatus and processing of image data to be executed by the CPU 201. For example, the ROM 202 stores a dither mask and pass mask (to be described later), a threshold table, and the like. The RAM 203 temporarily saves various data such as image data used for control of the inkjet printing apparatus and a print signal to be supplied to the printhead.

The gate array 204 supplies a print signal to the printhead 15, and performs data transfer between the image input unit 206, the CPU 201, and the RAM 203. A printhead driver 207 drives the printhead 15 in accordance with a print signal output from the control unit 20 to discharge ink. A main scanning encoder 213 detects the position of the carriage 11 in the main scanning direction (X-axis), and a sub-scanning encoder 214 detects the conveyance amount of the print medium 12 in the sub-scanning direction (Y-axis). The control unit 20 generates a driving signal in accordance with the carriage position/print medium conveyance amount detected by the main scanning encoder 213 and the sub-scanning encoder 214. A main scanning motor driver 209 and a sub-scanning motor driver 211 drive a main scanning motor 210 and a sub-scanning motor 212 in accordance with the driving signal generated by the control unit 20, and performs the conveyance operation of the carriage 11 and print medium 12.

The gate array 204 and CPU 201 of the control unit 20 convert image data received from the external apparatus 205 via the image input unit 206 into print data, and store the print data in the RAM 203. The control unit 20 synchronously drives the drivers 207, 209, and 211 to control a print operation on the print medium 12 by the printhead 15. As a result, a print image corresponding to the print data is formed on the print medium 12. The heating mechanism 14 constituted by a hot air fan or the like is driven in accordance with a signal output from the control unit 20, and heats the image-printed print medium 12. A display unit/operation unit 215 of the inkjet printing apparatus presents the user with the settings of various print conditions such as the standard setting of a reactive liquid print amount (discharge amount), and individually accepts a change of a setting.

### <Head Configuration>

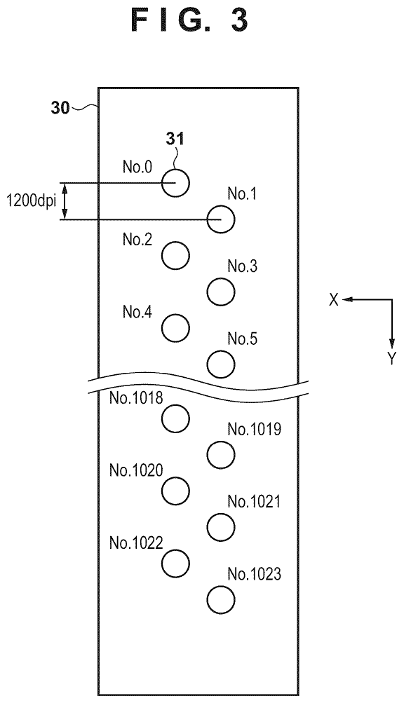

FIG. 3 is a schematic view of an orifice forming substrate 30 of the printhead 15 when viewed from the orifice surface. In the printhead 15, an orifice array for one color is formed by 1,024 orifices 31 arrayed at a density of 1,200 per inch in the Y direction. A direction in which the orifices are arrayed is a direction crossing the X-axis direction in which the printhead 15 scans.

The printhead 15 discharges droplets of black (K), cyan (C), magenta (M), and yellow (Y) inks as the first inks by discharge energy generated by printing elements such as electrothermal transducers (heaters) or piezoelectric elements. The printhead 15 discharges droplets of a white (W) ink containing a white color material as the second ink. Similarly, the printhead 15 discharges a reactive liquid 1 (RCT1) and a reactive liquid 2 (RCT2) as reactive liquids. The reactive liquids 1 and 2 act as adjuvants in image printing that contact ink and react with solid contents such as a color material and resin particles contained in the ink to promote the coagulation. Details of the inks and reactive liquids will be described later.

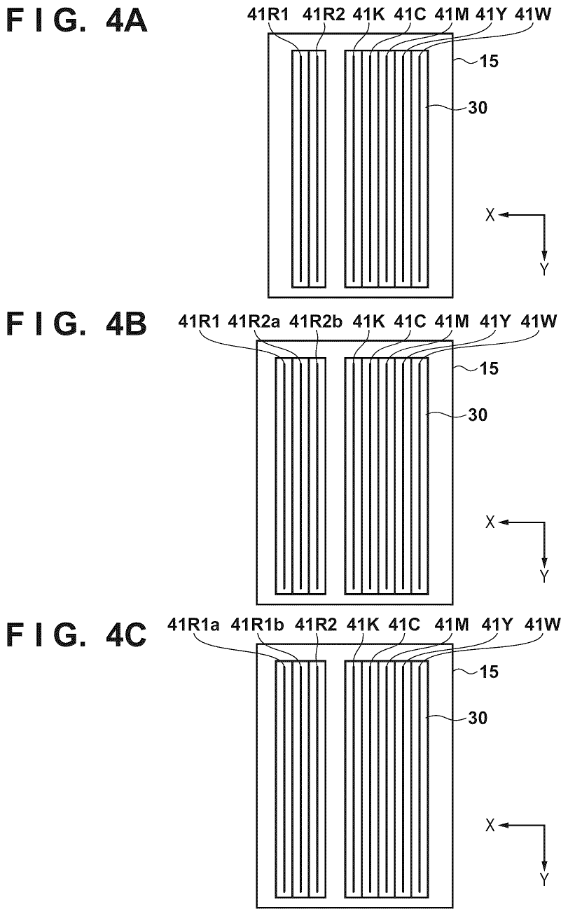

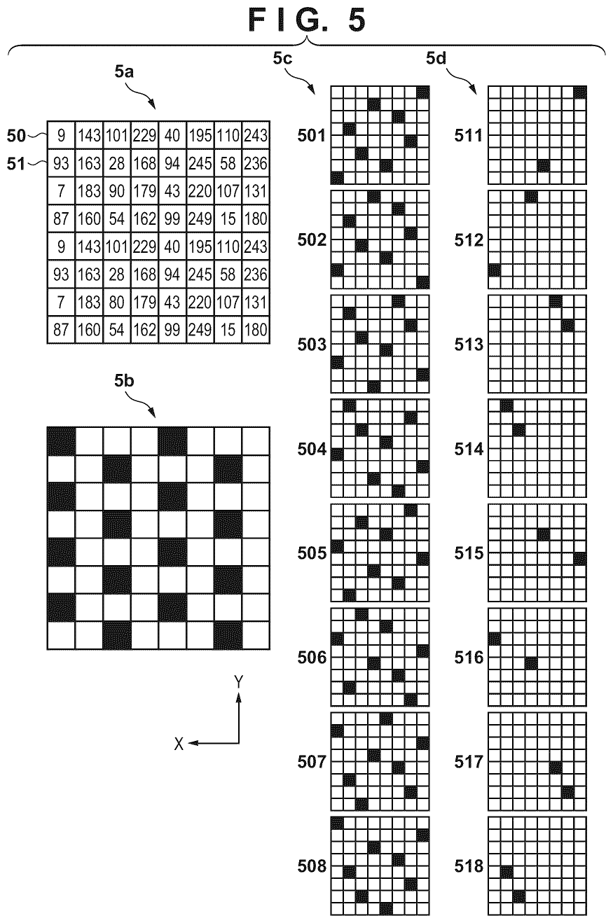

FIG. 4A is a schematic view of the printhead 15 when viewed from the orifice surface. In FIG. 4A, seven orifice array forming substrates are implemented. The seven orifice array forming substrates are a black orifice array 41K, a cyan orifice array 41C, a magenta orifice array 41M, a yellow orifice array 41Y, a white orifice array 41W, a reactive liquid 1 orifice array 41R1, and a reactive liquid 2 orifice array 41R2. A droplet discharged from each orifice of the printhead is about 4 ng, and a droplet can be discharged at a driving frequency of 21 kHz at maximum.

### <Compositions of Inks>

The compositions of the first and second inks used in this embodiment will be explained. In the following description, “part” or “%” is the mass standard, unless otherwise specified.

The first inks (color inks) contain color material pigments other than white, water-soluble resin particles, and water-soluble organic solvents. As described above, the first inks are black ink, cyan ink, magenta ink, and yellow ink, and black, cyan, magenta, and color material pigments are used as their color materials. As will be described later, these color material pigments are prepared as dispersion solutions in an aqueous solution, and then compounded with other predetermined material components to adjust the inks.

The second ink (white ink) is white ink containing a white color material as the color material, water-soluble resin particles, and a water-soluble organic solvent. As the color material of the white ink, titanium oxide particles are preferably used. Titanium oxide has rutile, anatase, and brookite crystal structures. Among them, titanium oxide is preferably rutile of low photocatalytic activity. The titanium oxide manufacturing method includes a sulfuric acid method and a chlorine method. The content (mass %) of titanium oxide particles in ink is preferably 5 mass % or more and 20 mass % or less with respect to the total mass of the ink in terms of ink stability.

The zeta potential of titanium oxide particles in pure water is preferably 0 mV or higher. The zeta potential is an index representing the charge state of the surface of titanium oxide particles, and can be measured using electrophoretic light scattering. When the positive charge amount of the surface of titanium oxide particles is larger than the negative charge amount, the particles are easily adsorbed by a resin with an anionic group, improving the dispersion stability of titanium oxide. To prevent excessive consumption of the anionic group of the resin and ensure a satisfactory electrostatic repulsion between titanium oxide particles, the zeta potential is preferably 40 mV or less. The second ink is white ink mainly containing the above-mentioned color material, but may contain another color material unless whiteness is impaired, in order to adjust a slight white tint visible under reflected light or the like.

The boiling point of the water-soluble organic solvent is preferably 150° C. or more and 300° C. or less in terms of the wettability and moisture retention of the face surface of the printhead. Preferable examples of the water-soluble organic solvent are ketone compounds such as acetone and cyclohexanone in terms of the function of a film formation assistant to resin particles and the swelling and solubility of a resin layer-formed print medium. Other preferable examples of the water-soluble organic solvent are an ethylene glycol derivative such as tetraethylene glycol dimethyl ether, and a heterocyclic compound having a lactam structure typified by N-methyl-pyrrolidone or 2-pyrrolidone. From the viewpoint of the discharge performance, the content of the water-soluble organic solvent is preferably 3 wt % or more and 30 wt % or less.

Examples of the water-soluble organic solvent are alkyl alcohols having 1 to 4 carbon atoms such as methyl alcohol, ethyl alcohol, n-propyl alcohol, isopropyl alcohol, n-butyl alcohol, sec-butyl alcohol, and tert-butyl alcohol, amides such as dimethylformamide and dimethylacetamide, ketones or keto alcohols such as acetone and diacetone alcohol, ethers such as tetrahydrofuran and dioxane, polyalkylene glycols such as polyethylene glycol and polypropylene glycol, ethylene glycol, or alkylene glycols with alkylene groups containing 2 to 6 carbon atoms such as propylene glycol, butylene glycol, triethylene glycol, 1,2,6-hexanetriol, thioglycol, hexylene glycol, and diethylene glycol, lower alkyl ether acetates such as polyethylene glycol monomethyl ether acetate, glycerin, lower alkyl ethers of polyalcohol such as ethylene glycol monomethyl (or ethyl) ether, diethylene glycol methyl (or ethyl) ether, and triethylene glycol monomethyl (or ethyl) ether, polyalcohols such as trimethylolpropane and trimethylolethane, N-methyl-2-pyrrolidone, 2-pyrrolidone, and 1,3-dimethyl-2-imidazolidinone. The above-mentioned water-soluble organic solvents may be used alone or as mixtures. As water, deionized water is desirable. To apply desired physical properties if necessary, a surfactant, an anti-foaming agent, a preservative, a defoamer, and the like can be properly added together with the above-mentioned components.

Resin particles used in this form will be explained. The first and second inks contain water-soluble resin particles to make a print medium and a color material into tight contact with each other and improve the scratch resistance (fixing characteristic) of a print image. The resin particles melt by heat, and film formation of the resin particles and drying of a solvent contained in ink are performed by a heater. The term “resin particles” means polymer particles present in a state in which they are dispersed in water. Examples of the water-soluble resin emulsion are acrylic resin particles synthesized by emulsion polymerization of monomers such as (meth)acrylic acid alkyl ester and (meth)acrylic acid alkyl amide, styrene-acrylic resin particles synthesized by emulsion polymerization of styrene monomers such as (meth)acrylic acid alkyl esters and (meth)acrylic acid alkyl amides, polyethylene resin particles, polypropylene resin particles, polyurethane resin particles, and styrene-butadiene resin particles. Examples of the water-soluble resin emulsion may be core-shell resin particles in which the polymer composition differs between the core and shell constituting the resin particle, and resin particles obtained by emulsion polymerization around pre-synthesized acrylic particles used as seed particles to control the particle size. Further, examples of the water-soluble resin emulsion may be hybrid resin particles obtained by chemically bonding different resin particles such as acrylic resin particles and urethane resin particles.

The “polymer particles present in a state in which they disperse in water” may be the form of resin particles obtained by single polymerization of a monomer with a dissociable group or copolymerization of a plurality of types of monomers, that is, a so-called self-dispersion resin particle dispersing element. Examples of the dissociable group are a carboxyl group, a sulfonic acid group, and a phosphate acid group, and examples of the monomer with the dissociable group are acrylic acid and methacrylic acid. Further, the polymer particles may be a so-called emulsification dispersion resin particle dispersing element obtained by dispersing resin particles in an emulsifier. As the emulsifier, a material with anionic charges is available regardless of low molecular mass or high molecular mass.

### <Compositions of Reactive Liquids>

In this embodiment, two different types of reactive liquids, that is, the reactive liquid 1 (RCT1) and the reactive liquid 2 (RCT2) are used. Each reactive liquid contains a reactant that reacts with a color material component contained in ink to coagulate the color material or cause gelatinization of it. Here, the reactant is a component that can reduce the dispersion stability of ink when the reactant is mixed on a print medium or the like with the ink containing a pigment stably dispersed in an aqueous medium due to the action of an ionic group. More specifically, a polyvalent metal salt, a water-soluble cationic polymer with a cationic group, a water-soluble organic acid, or the like can be used as the reactant of the reactive liquid.

The reactive liquid 1 preferably contains at least a multivalent metal salt as the reactant component. The reactive liquid 1 is a reactive liquid mainly used for color ink, and can control a coagulation state when mixed with color ink and improve image quality characteristics such as gloss and color development. A reactive liquid containing many reactant components such as a cationic polymer with a strong coagulation action when mixed with color ink strengthens the coagulation of ink dots on a print medium. This hinders leveling (smoothing) of ink dots and degrades the image quality characteristics of a printed product.

The reactive liquid 2 is a reactive liquid mainly used for white ink, and contains at least a cationic polymer as the reactant component. The cationic polymer contains many ionic polar groups in a single polymer molecule, has high charge density, and thus excels at reducing the dispersibility of a color material pigment. White ink is used to control the light blocking effect of an image when a transparent film or the like is used as a print medium. In this case, it is necessary to form a white ink layer excellent in shielding (masking) against light coming from the opposite side of a print surface, and the content of the color material is larger than that of color ink. To properly coagulate white ink containing a large amount of color material on a print medium and form a stacked image with color ink, at least the cationic polymer is preferably contained as a reactant component used for the reactive liquid 2.

In this embodiment, the content of the reactive component is preferably 0.1 mass % or more and 90.0 mass % or less, and more preferably 1.0 mass % or more and 70.0 mass % or less with respect to the total mass of the composition contained in the reactive liquid.

### <Preparation (Adjustment) Method of Inks and Reactive Liquids>

### Resin Particle Dispersion Liquid

A resin particle dispersion liquid used in the first embodiment was prepared by, first, dropping and adding the following three additive liquids little by little while stirring them in a state in which they were heated to 70° C. in a nitrogen atmosphere, and then polymerizing them for 5 h. The additive liquids were a hydrophobic monomer consisting of 28.5 parts of methyl methacrylate, a solution mixture containing a hydrophilic monomer containing of 4.3 parts of sodium p-styrene sulfonate and 30 parts of water, and a solution mixture containing a polymerization initiator consisting of 0.05 parts of potassium persulfate and 30 parts of water. In this manner, a 20-mass % resin particle dispersion liquid was obtained.

### Black Ink

### (K1) Preparation of Dispersion Liquid

An anionic polymer P-1 [styrene/butyl acrylate/acrylic acid copolymer (polymerization ratio (weight ratio)=30/40/30), acid value of 202, weight-average molecular weight of 6500] was prepared. The polymer was neutralized with an aqueous potassium hydroxide solution and diluted with ion-exchanged water, thus preparing a homogeneous 10-mass % polymer solution.

Then, 600 g of the polymer solution, 100 g of carbon black, and 300 g of ion-exchanged water were mixed and mechanically stirred for a predetermined time. The mixture was then subjected to centrifugal separation processing to remove undispersed substances containing coarse particles, thus obtaining a black dispersion liquid. The obtained black dispersion liquid had a pigment concentration of 10 mass %.

### (K2) Preparation of Ink

An ink was prepared by using the black dispersion liquid and adding the following components to it to have a predetermined concentration. After these components were fully mixed and stirred, they were pressure-filtrated through a microfilter of a 2.5-μm pore size (available from Fujifilm), thus preparing a pigment ink having a pigment concentration of 2 mass %.

| | | |
|---|---|---|
| the black dispersion liquid | 20 | parts |
| the resin particle dispersion liquid | 40 | parts |
| Zonyl FSO-100 (fluorine surfactant | 0.05 | parts |
| available from DuPont) | | |
| 2-methyl-1,3-propanediol | 15 | parts |
| 2-pyrrolidone | 5 | parts |
| acetylene glycol EO adduct (available | 0.5 | parts |
| from Kawaken Fine Chemicals) | | |

| | |
|---|---|
| ion-exchanged water | balance |

### Cyan Ink

### (C1) Preparation of Dispersion Liquid

An AB block polymer having an acid value of 250 and a number average molecular weight of 3000 was prepared by a conventional method using benzyl acrylate and methacrylic acid as raw materials. The polymer was neutralized with an aqueous potassium hydroxide solution and diluted with ion-exchanged water, thus preparing a homogeneous 50-mass % polymer solution.

Then, 200 g of the polymer solution, 100 g of C.I. pigment blue 15:3, and 700 g of ion-exchanged water were mixed and mechanically stirred for a predetermined time. The mixture was then subjected to centrifugal separation processing to remove undispersed substances containing coarse particles, thus obtaining a cyan dispersion liquid. The obtained cyan dispersion liquid had a pigment concentration of 10 mass %.

### (C2) Preparation of Ink

An ink was prepared by using the cyan dispersion liquid and adding the following components to it to have a predetermined concentration. After these components were fully mixed and stirred, they were pressure-filtrated through a microfilter of a 2.5-μm pore size (available from Fujifilm), thus preparing a pigment ink having a pigment concentration of 2 mass %.

| | | |
|---|---|---|
| the cyan dispersion liquid | 20 | parts |
| the resin particle dispersion liquid | 40 | parts |
| Zonyl FSO-100 (fluorine surfactant | 0.05 | parts |
| available from DuPont) | | |
| 2-methyl-1,3-propanediol | 15 | parts |
| 2-pyrrolidone | 5 | parts |
| acetylene glycol EO adduct (available | 0.5 | parts |
| from Kawaken Fine Chemicals) | | |

| | |
|---|---|
| ion-exchanged water | balance |

### Magenta Ink

### (M1) Preparation of Dispersion Liquid

An AB block polymer having an acid value of 300 and a number average molecular weight of 2500 was prepared by a conventional method using benzyl acrylate and methacrylic acid as raw materials. The polymer was neutralized with an aqueous potassium hydroxide solution and diluted with ion-exchanged water, thus preparing a homogeneous 50-mass % polymer solution.

Then, 100 g of the polymer solution, 100 g of C.I. pigment red 122, and 800 g of ion-exchanged water were mixed and mechanically stirred for a predetermined time. The mixture was then subjected to centrifugal separation processing to remove undispersed substances containing coarse particles, thus obtaining a magenta dispersion liquid. The obtained magenta dispersion liquid had a pigment concentration of 10 mass %

### (M2) Preparation of Ink

An ink was prepared by using the magenta dispersion liquid and adding the following components to it to have a predetermined concentration. After these components were fully mixed and stirred, they were pressure-filtrated through a microfilter of a 2.5-μm pore size (available from Fujifilm), thus preparing a pigment ink having a pigment concentration of 3 mass %.

| | | |
|---|---|---|
| the magenta dispersion liquid | 30 | parts |
| the resin particle dispersion liquid | 40 | parts |
| Zonyl FSO-100 (fluorine surfactant | 0.05 | parts |
| available from DuPont) | | |
| 2-methyl-1,3-propanediol | 15 | parts |
| 2-pyrrolidone | 5 | parts |
| acetylene glycol EO adduct (available | 0.5 | parts |
| from Kawaken Fine Chemicals) | | |

| | |
|---|---|
| ion-exchanged water | balance |

### Yellow Ink

### (Y1) Preparation of Dispersion Liquid

An anionic polymer P-1 was neutralized with an aqueous potassium hydroxide solution and diluted with ion-exchanged water, thus preparing a homogeneous 10-mass % polymer solution.

Then, 300 g of the polymer solution, 100 g of C.I. pigment yellow 74, and 600 g of ion-exchanged water were mixed and mechanically stirred for a predetermined time. The mixture was then subjected to centrifugal separation processing to remove undispersed substances containing coarse particles, thus obtaining a yellow dispersion liquid. The obtained yellow dispersion liquid had a pigment concentration of 10 mass %.

### (Y2) Preparation of Ink

After the following components were mixed, fully stirred, dissolved, and dispersed, they were pressure-filtrated through a microfilter of a 1.0-μm pore size (available from Fujifilm), thus preparing a pigment ink having a pigment concentration of 3 mass %.

| | | |
|---|---|---|
| the yellow dispersion liquid | 30 | parts |
| the resin particle dispersion liquid | 40 | parts |
| Zonyl FSO-100 (fluorine surfactant | 0.025 | parts |
| available from DuPont) | | |
| 2-methyl-1,3-propanediol | 15 | parts |
| 2-pyrrolidone | 5 | parts |
| acetylene glycol EO adduct (available | 1 | part |
| from Kawaken Fine Chemicals) | | |

| | |
|---|---|
| ion-exchanged water | balance |

### White Ink

### (W1) Preparation of White Dispersion Liquid

An anionic polymer P-1 [styrene/butyl acrylate/acrylic acid copolymer (polymerization ratio (weight ratio)=30/40/30), acid value of 202, weight-average molecular weight of 6500] was prepared. The polymer was neutralized with an aqueous potassium hydroxide solution and diluted with ion-exchanged water, thus preparing a homogeneous 10-mass % polymer solution.

Then, 150 g of the polymer solution, 500 g of titanium oxide, and 350 g of ion-exchanged water were mixed, and titanium oxide was dispersed using a homogenizer. The mixture was then subjected to centrifugal separation processing to remove undispersed substances containing coarse particles, and a proper amount of ion-exchanged water was added, thus obtaining a white dispersion liquid. The obtained white dispersion liquid had a pigment concentration of 30 mass %.

### (W2) Preparation of White Ink

A white ink was prepared by using the white dispersion liquid and mixing the following components with the white dispersion liquid. After these components were fully stirred, dissolved, and dispersed, they were pressure-filtrated through a microfilter of a 2.5-μm pore size (available from Fujifilm), thus preparing a pigment ink having a pigment concentration of 4 mass %.

| | | |
|---|---|---|
| the white dispersion liquid | 40 | parts |
| the aqueous resin emulsion dispersion liquid | 40 | parts |
| Zonyl FSO-100 (fluorine surfactant | 0.025 | parts |
| available from DuPont) | | |
| 2-methyl-1,3-propanediol | 15 | parts |
| 2-pyrrolidone | 5 | parts |
| acetylene glycol EO adduct (available | 1 | parts |
| from Kawaken Fine Chemicals) | | |

| | |
|---|---|
| ion-exchanged water (available | balance |
| from Kawaken Fine Chemicals) | |

### Reactive Liquid 1 (RCT1)

Magnesium sulfate (available from Fujifilm Wako Pure Chemical Corporation) was used as a reactant component, and RCT1 was prepared by mixing the following components.

| | | |
|---|---|---|
| magnesium sulfate | 2 | parts |
| 2-pyrrolidone | 5 | parts |
| 2-methyl-1,3-propanediol | 15 | parts |
| acetylene glycol EO adduct (available | 0.5 | parts |
| from Kawaken Fine Chemicals) | | |

| | |
|---|---|
| ion-exchanged water | balance |

### Reactive Liquid 2 (RCT2)

A cationic polymer was used as a reactant component, and RCT2 was prepared by mixing the following components. The cationic polymer was compounded to have the following weight in solid content conversion in consideration of the solid contents of a solution used.

| | | |
|---|---|---|
| cationic polymer (UNISENCE FPA100LU | 2 | parts |
| available from Senka) | | |
| 2-pyrrolidone | 5 | parts |
| 2-methyl-1,3-propanediol | 15 | parts |
| acetylene glycol EO adduct (available | 0.5 | parts |
| from Kawaken Fine Chemicals) | | |

| | |
|---|---|
| ion-exchanged water | balance |

### <Operation of Apparatus>

In this embodiment, an image is printed according to a multi-pass printing method of printing an image in a unit area (partial area) on a print medium by a plurality of scans. In each of the scans, droplets (inks and reactive liquids) are discharged in accordance with print data that defines discharge or non-discharge of droplets to respective pixels.

In this embodiment, print data corresponding to each of scans is generated from image data by using a dither mask and a pass mask. A general processing method of image data in a case where printing (image formation) is performed by eight passes using the dither mask and the pass mask will be described below. Note that image data is 8-bit data capable of representing 256 tone values of 0 to 255 for descriptive convenience. Here, both the dither mask and the pass mask have a size corresponding to an area of 8 pixels×8 pixels corresponding to the unit area.

FIG. 5 is a view for explaining general print data generation. That is, FIG. 5 shows a method of processing the above-mentioned image data to generate print data. Note that 5a is a view schematically showing an example of the dither mask. 5b is a schematic view showing binary data generated by applying the dither mask shown in 5a to image data having a tone value (information representing tone) “64”. Further, 5c is a schematic view showing an example of pass masks 501 to 508 of droplets respectively corresponding to the first to eighth scans. In each scan, a maximum of one dot per pixel is printed as a unit pixel of 1/2400 inches in the X direction and 1/1200 inches in the Y direction. 5d is a schematic view showing print data 511 to 518 that are generated by applying the pass masks 501 to 508 in 5c to the binary data shown in 5b, and correspond to the respective first to eighth scans. The pass masks 501 to 508 in 5c are mask patterns with which a total of one dot is printed in each pixel by eight scans. However, mask patterns with which two or more dots are printed in each pixel are also available, and the mask patterns can be set in accordance with a desired droplet print amount for a unit area on a print medium.

As shown in 5a, the dither mask defines different thresholds for respective pixels. When the tone value of multi-value data is larger than a threshold to be compared in each pixel, the multi-value data is converted into binary data (1-bit data) representing “discharge of a droplet” to the pixel. In contrast, when the tone value of multi-value data is equal to or smaller than the threshold to be compared in each pixel, the multi-value data is converted into binary data representing “non-discharge of a droplet” to the pixel. Note that a form in which multi-value data of the same value is input to all pixel areas in a given unit area will be explained below, but multi-value data of different values for respective pixel areas may be input.

For example, when the tone value of multi-value data in a previous pixel is “64”, a threshold in a pixel 50 of the dither mask shown in 5a is “9” (<64), and thus multi-value data corresponding to the pixel 50 is converted into binary data representing “discharge of a droplet”. A threshold in a pixel 51 is “93” (≥64), and multi-value data corresponding to the pixel 51 is converted into binary data representing “non-discharge of a droplet”. In this manner, the dither mask shown in 5a is used to generate binary data shown in 5b from multi-value data representing the tone value “64”.

As represented in the pass masks 501 to 508 of 5c, the pass mask is constituted by arranging print-permitted pixels in which discharge of a droplet is permitted, and print-inhibited pixels in which discharge of a droplet is inhibited. Note that filled portions in each of the pass masks 501 to 508 in 5c represent print-permitted pixels, and blank portions represent print-inhibited pixels.

Print data corresponding to each scan is generated by ANDing input binary data and a pass mask corresponding to each scan. That is, when binary data representing discharge of a droplet is input for a print-permitted pixel, it is converted into print data representing discharge of a droplet. To the contrary, even when binary data representing discharge of a droplet is input for a print-inhibited pixel, it is converted into print data representing non-discharge of a droplet.

More specifically, a pass mask represented by the pass mask 501 in 5c corresponding to the first scan is applied to binary data shown in 5b to distribute the binary data and generate print data corresponding to the first scan that is represented by the print data 511 in 5d. Similarly, the binary data shown in 5b is distributed to the respective second to eighth scans to generate print data corresponding to the second to eighth scans that are represented by the print data 512 to 518 in 5d. In each of the first to eighth scans, droplets are discharged in accordance with the thus-generated print data, thereby printing an image.

The above-mentioned multi-pass printing method will be described in detail below. Note that a case where image data having a tone value of 64 is input will be explained here. As described above, when image data having a tone value of 64 is input, print data respectively represented by the print data 511 to 518 in 5d are generated, and droplets are discharged in accordance with the print data.

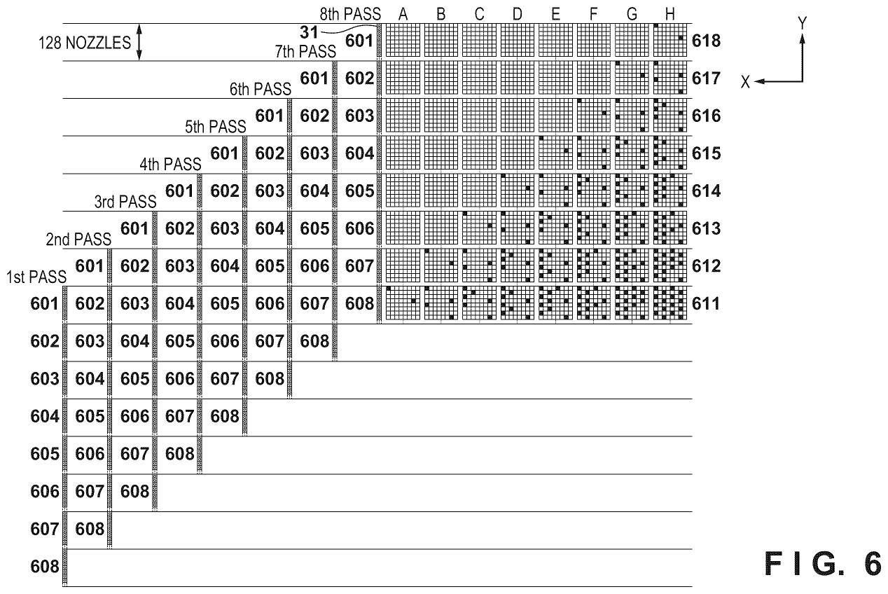

FIG. 6 is a view for explaining a general multi-pass printing method. FIG. 6 shows a state in which printing is performed in a unit area on a print medium by eight print scans by a printhead having 1,024 orifices in one orifice array. FIG. 6 shows an example in which the pass mask of 8 pixels×8 pixels shown in 5c is used for descriptive convenience. Also, FIG. 6 shows an example in which a printhead having one orifice array is used as the printhead 15.

The respective orifices provided in an orifice array for discharging a droplet are divided into eight print groups 601, 602, 603, 604, 605, 606, 607, and 608 in the Y direction.

In the first print scan, droplets are discharged from the print group 601 to an area 611 on the print medium 12 in accordance with the print data 511 in 5d. As a result, droplets are discharged to positions represented in black in A of FIG. 6 on the print medium. Then, the print medium 12 is relatively conveyed by a distance corresponding to 128 (=1024/8) orifices in the Y direction with respect to the printhead 15. After that, the second print scan is performed.

In the second print scan, droplets are discharged from the print group 602 to the area 611 on the print medium in accordance with the print data 512 in 5d. In addition, droplets are discharged from the print group 601 to an area 612 in accordance with the print data 511 in 5d. As a result of the second print scan, an image as represented in the area 611 of “B column” is formed on the print medium 12.

Subsequently, scanning of the printhead 15 and relative conveyance of the print medium 12 are alternately repeated. After the eighth print scan is performed, an image as represented in the area 611 of “H column” is formed on the print medium 12, and discharge of droplets is completed for 25% of a printable pixel area.

A general example in a case where 8-pass printing is performed by a printhead having 1,024 orifices used in this embodiment has been explained.

### <Image Printing of Stacked Layer and Non-Stacked Layer>

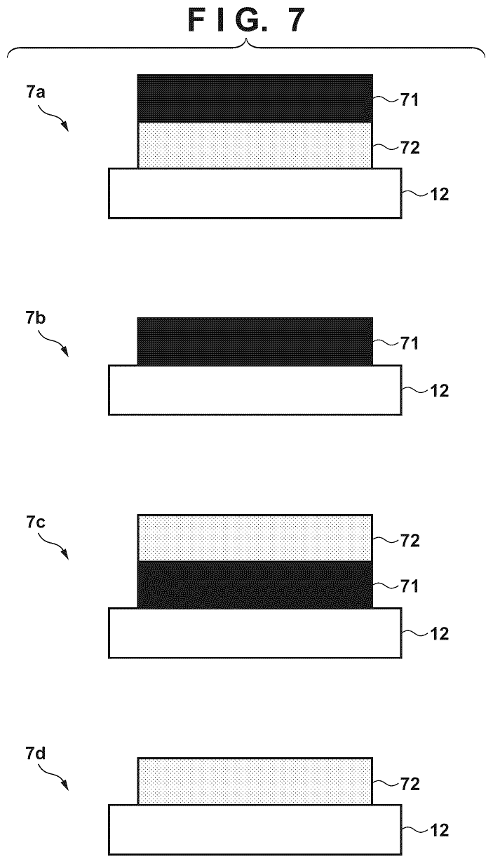

Image printing of stacked and non-stacked layers using color ink, white ink, and two types of reactive liquids will be explained. When at least either of white ink and color ink is printed on the print medium 12, four types of print sections shown in FIG. 7 can be printed.

FIG. 7 is a schematic view showing the sections of a stacking area and non-stacking area. In 7a, a white ink layer 72 is formed on the print medium 12, and a color ink layer 71 is formed on the white ink layer 72. In 7b, only the color ink layer 71 is formed on the print medium 12. In 7c, the color ink layer 71 is formed on the print medium 12, and the white ink layer 72 is formed on the color ink layer 71. In 7d, only the white ink layer 72 is formed on the print medium 12.

The stacking area takes a plurality of forms such as a form in which the stacking area is formed from a plurality of color ink layers 71 and a shielding layer. In this embodiment, an area where the print section is 7a or 7c will be called a “stacking area”, and an area where the print section is 7b or 7d will be called a “non-stacking area” for descriptive convenience. A layer formed from white ink in the stacking area is sometimes described as a “white ink layer” or “shielding layer”. A layer formed from color ink is sometimes described as a “color ink layer”.

An image having a stacking area can be printed by adjusting the pass masks shown in 5c assigned to each orifice array of the printhead 15.

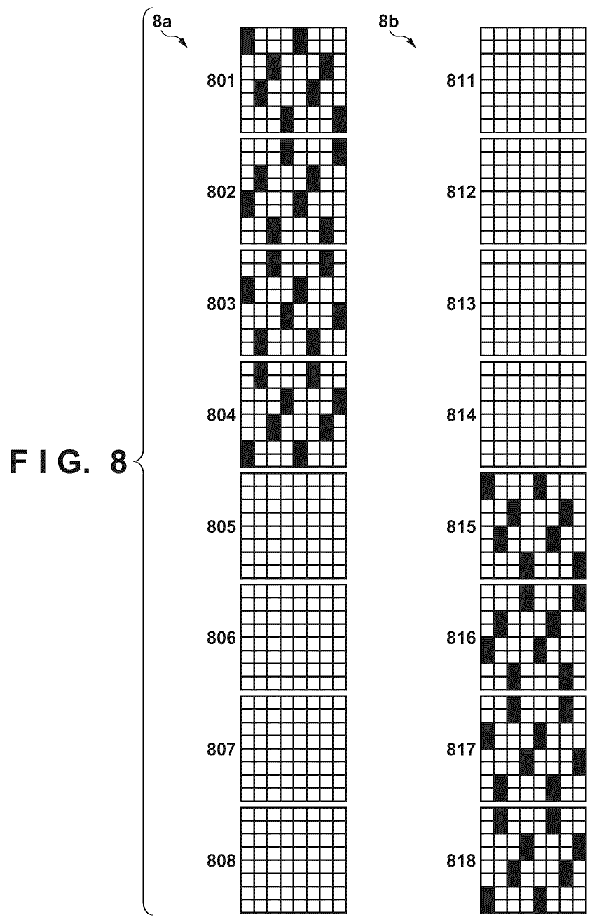

FIG. 8 is a schematic view of pass masks set for an orifice array that can be used in printing of an image having a stacking area. In 8a, all print-permitted pixels in the unit area are set in the first to fourth print scans among a total of eight print scans. Eight pass masks are sequentially applied in eight print scans to an orifice array for which 8a is set, such that a pass mask 801 is applied in the first print scan and a pass mask 802 is applied in the second print scan. In the fifth to eighth print scans, no printing is performed with this orifice array.

In 8b, all print-permitted pixels in the unit area are set in the fifth to eighth print scans. Eight pass masks are sequentially applied in eight print scans to an orifice array for which 8b is set, such that a pass mask 811 is applied in the first print scan and a pass mask 812 is applied in the second print scan. In the first to fourth print scans, no printing is performed with this orifice array.

From this, the pass masks in 8b are set for the orifice arrays of the color ink and reactive liquid 1, the pass masks in 8a are set for the orifice arrays of the white ink and reactive liquid 2, and image printing of a stacked layer as shown in FIG. 7 becomes possible. That is, the white ink and the reactive liquid 2 are printed in the first to fourth print scans, and the color ink and the reactive liquid 1 are printed in the fifth to eighth print scans. By these print steps, an image in which the color ink layer 71 is formed on the shielding layer can be printed.

### <Operation of Image Processing in Image Printing>

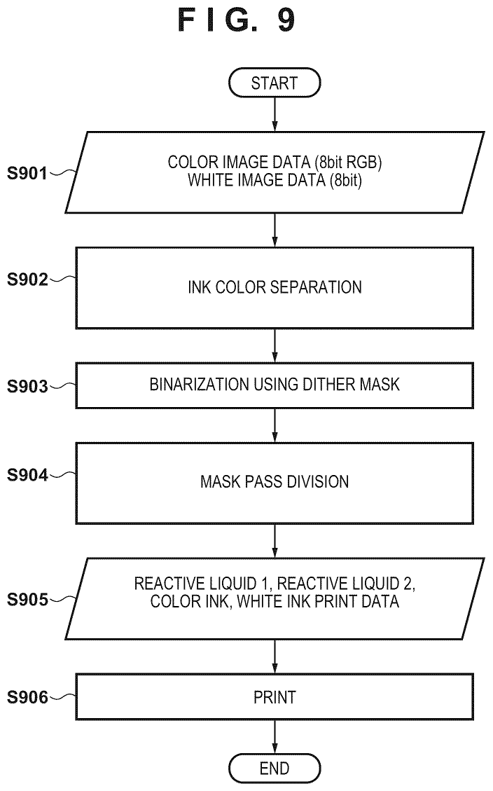

FIG. 9 is a flowchart showing image processing. The program of this sequence is stored in, for example, the ROM 202 and executed by the CPU 201. This sequence starts when the control unit 20 accepts input of RGB data from the external apparatus 205 via the image input unit 206.

In step S901, the control unit 20 accepts input of color image data (8-bit tone for each of R, G, and B). Similarly, the control unit 20 accepts input of white image data (8-bit tone). In the following description, 8-bit color ink data RGB is sometimes referred to as color image data, and 8-bit white ink data is sometimes referred to as white image data.

In step S902, the control unit 20 converts color image data into multi-value color ink data corresponding to the respective color inks C, M, Y, and K used for image printing by ink color separation processing. More specifically, while looking up a color conversion lookup table (LUT), the control unit 20 converts the input image data for each predetermined area into color ink data corresponding to a plurality of ink colors available in the printing apparatus. The control unit 20 executes similar processing even for white image data to convert the input image data into white ink data. In ink color separation processing, 8-bit image data corresponding to each orifice array 41 is generated based on a print mode determined in advance for each type of print medium, and a three-dimensional (3D)-LUT.

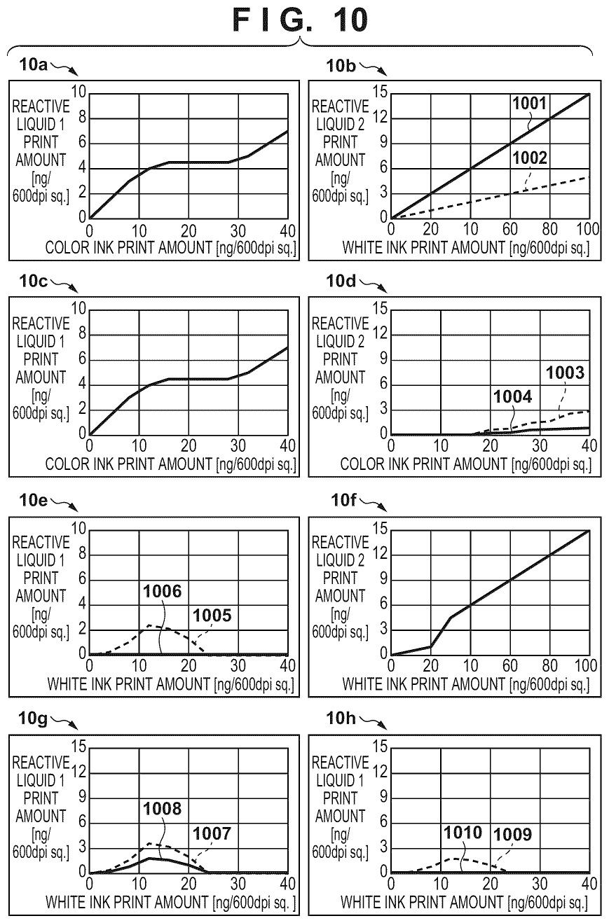

FIG. 10 is a graph showing the relationship between the ink print amount and the reactive liquid print amount. 10a shows an example of the print amount (discharge amount) of the reactive liquid 1, and defines the relationship of the print amount of the reactive liquid 1 with respect to the sum of the print amounts of the color inks C, M, Y, and K. The abscissa represents the sum of the print amounts of the color inks per predetermined area (for example, 1/600 inch square), and the ordinate represents the total print amount of the reactive liquid 2 per unit area. 10b shows an example of the print amount of the reactive liquid 2, and defines the relationship between the print amount of white ink and that of the reactive liquid 2. The print amounts of the reactive liquids 1 and 2 are determined at predetermined ratios to the sum of the inks in the predetermined area based on the relationships represented by solid lines in 10a and 10b, and are converted into 8-bit image data (RCT data) corresponding to the printing. As will be described later, the print amount of reactive liquid is changed for the same amount of color ink based on whether the print target area is a stacking area or a non-stacking area.

In step S903, the control unit 20 binarizes the color ink data, the white ink data, and the RCT data using a dither mask. Binarization using the dither mask is the same as the processing explained with reference to FIG. 5. During the processing, a dither mask and a pass mask stored in the ROM 202 are deployed in the RAM 203, and data generated in each step is also stored in the RAM 203.

In step S904, the control unit 20 performs pass division on the binarized color ink data, white ink data, and RCT data. In step S905, the control unit 20 generates, based on the data having undergone pass division for each scan, print data for driving the printhead. In step S906, the control unit 20 synchronously drives the drivers 207, 209, and 211 to execute image printing.

### <Control of Print Amount of Reactive Liquid>

A characteristic configuration of this embodiment performed in step S902 will be explained below. More specifically, a method and effect of changing the print amount of reactive liquid between the stacking area and the non-stacking area for the same amount of color ink will be explained. Especially in the first embodiment, control of the print amount of the reactive liquid 2 for the color ink layer 71 in a case where the stacking area is 7a and the non-stacking area is 7b will be explained.

The reactive liquid 1 is a reactive liquid mainly used for color ink, and preferably contains a multivalent metal salt to improve image quality characteristics. In this embodiment, the reactive liquid 1 contains magnesium sulfate as the multivalent metal salt. The multivalent metal salt is preferable in terms of controlling the coagulation reaction with color ink, but unreacted metal ions (cations) and anions may remain and sub-μ to several-μ small metal salt crystals may precipitate during drying of an ink film. Since the reactive liquid 1 contains magnesium sulfate, sulfate crystals, magnesium salt crystals, and the like may precipitate from anionic or cationic components dissociated in the ink film.

FIG. 11 is a view showing precipitates 115 generated on the image surface. 11a schematically shows a state in which several-μ metal salt crystals have precipitated as the precipitates 115 on the surface of a stacking area, and 11b schematically shows a state in which the precipitates 115 formed in a non-stacking area. The precipitates 115 are generated much more near the surface layer of the color ink layer 71, and the generation amount changes depending on even the drying conditions of the ink film. In the stacking area, the ink print amount per unit area is higher than that in the non-stacking area, and the ink film dries slowly. As a result, the growth of the metal salt crystals progresses, and the precipitates 115 tend to be generated much more. The sub-μ to several-μ precipitates 115 on the surface irregularly reflect light, impairing the color development of the color ink layer 71. Further, the precipitates 115 are made of metal salt crystals or the like, so they adsorb or hydrate moistures in air and promote the growth of precipitates. This may lead to a change of the image quality, that is, degradation of the stability of the image quality in accordance with an environment where a printed product is left.

In contrast, the reactive liquid 2 used for white ink is a reactive liquid containing a cationic polymer as the reactant component. Compared to the reactive liquid 1, the reactive liquid 2 hardly generates the precipitates 115 derived from the above-mentioned reactive liquid.

The inventor of the present disclosure has found that generation of precipitates near the color ink surface can be suppressed by using the reactive liquid 2 together with the reactive liquid 1 in color ink printing. Further, the inventor of the present disclosure has found that the image quality in the stacking area in 7a could be improved by increasing the print ratio of the reactive liquid 2 printed in the same print scan as that of color ink in the stacking area, compared to the non-stacking area.

It is considered to control printing so that the print ratio of the reactive liquid 2 to the stacking area becomes higher than that of the reactive liquid 2 to the non-stacking area. However, when the pass mask configuration in FIG. 8 is used, the print amount of the reactive liquid 1 is determined with respect to the total amount of color ink, and that of the reactive liquid 2 is determined with respect to the print amount of white ink. That is, the print amount of the reactive liquid 2 cannot be determined depending on the print amount of color ink. Thus, the ratio of the reactive liquid 2 to color ink in the stacking area is increased by adjusting the pass mask of the orifice array from which the reactive liquid 2 is discharged.

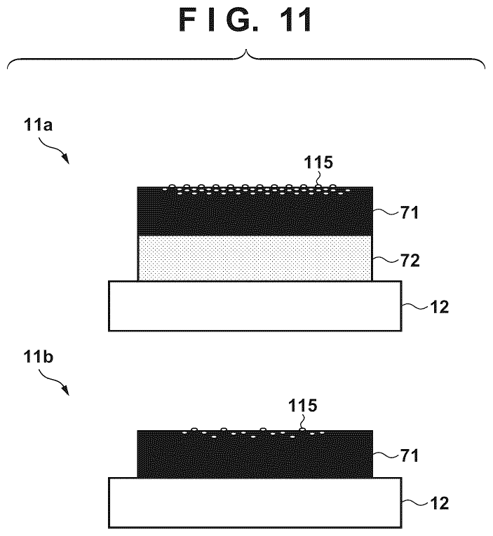

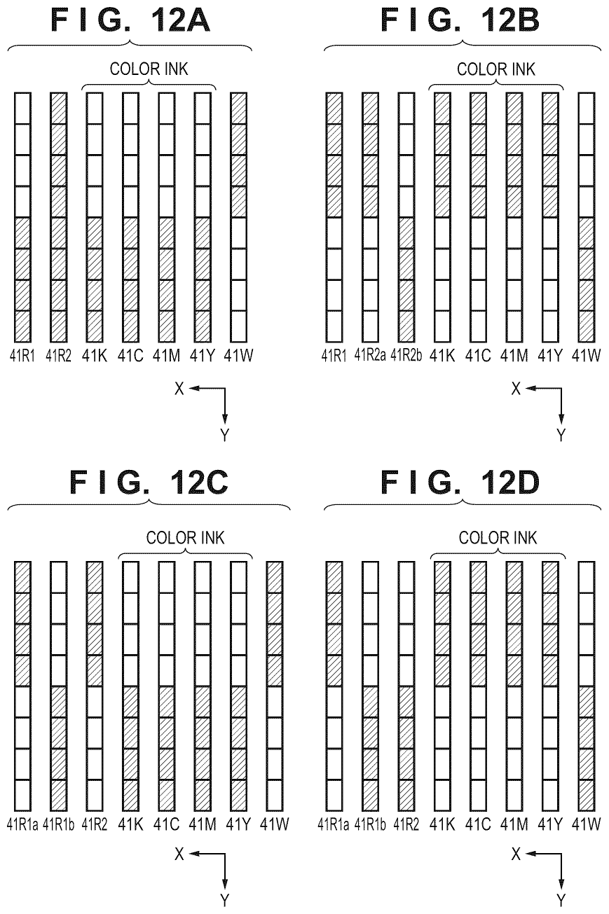

FIG. 12A is a view for explaining pass masks used in this embodiment. FIG. 12A shows pass masks respectively assigned to the seven orifice arrays shown in FIG. 4A in eight print scans. Hatched areas represent that ink is printed (discharged), and unhatched areas represent that ink is not printed (not discharged).

In FIG. 12A, white ink is printed in the first to fourth print scans (total of four times) on the upstream side in the conveyance direction. Color ink and the reactive liquid 1 are printed in the fifth to eighth print scans (total of four times) on the downstream side in the conveyance direction. The reactive liquid 2 is printed in the first to eighth print scans (total of eight times). Note that the pass masks shown in FIG. 12A set print-permitted pixels so that ink of one dot per pixel is printed in scans of eight passes, and a maximum of 32-ng ink can be printed per unit area.

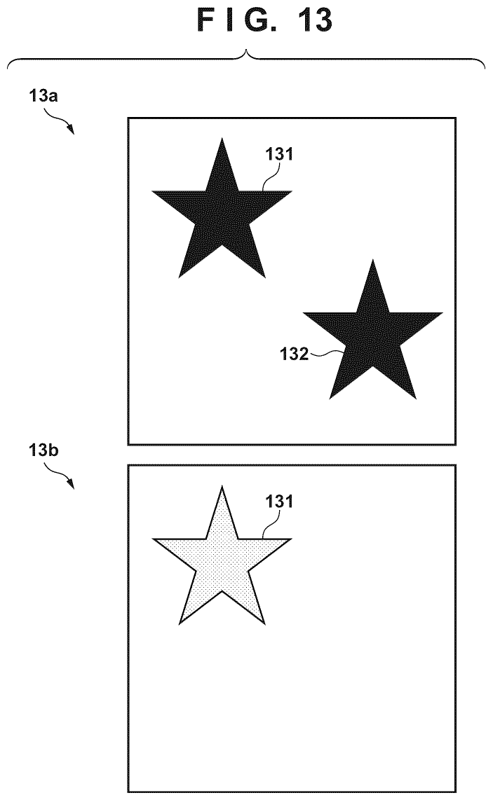

FIG. 13 is a view showing an example of an input image. The above configuration will be explained in correspondence with the example of input image data shown in FIG. 13. The input image in FIG. 13 is formed from RGB data (8 bits for each color) for the color inks shown in 13a, and W image data (8 bits) for the white ink shown in 13b. Color data of an image area 131 and that of an image area 132 in 13a have the same data value and are black data of RGB(0,0,0) here. The image area 131 is a stacking area, and maximum tone value data of W(0) is input for the image area 131 in 13b.

Since image data corresponding to the reactive liquid 1 is generated with respect to the print amount of color ink, the image data is generated for the image areas 131 and 132. Since image data corresponding to the reactive liquid 2 is generated with respect to the print amount of white ink, the image data is generated for only the image area 131.

With the pass masks in FIG. 12A, printing is performed from the orifice array of the reactive liquid 2 in all the first to eighth print scans. In the fifth to eighth print scans in which the color ink of the image area 131 is printed, both the reactive liquids 1 and 2 are printed with respect to the color ink. Since no print data of the reactive liquid 2 is generated for the image area 132, printing of the reactive liquid 2 in the non-stacking area is not performed.

Accordingly, the print ratio of the reactive liquid 2 printed in the same print scan as that of color ink in the stacking area can be increased in comparison with the non-stacking area. The above-described generation of precipitates in the stacking area can be effectively suppressed, improving the image quality. As the shielding layer becomes thicker, that is, as the print amount of white ink becomes larger, the precipitates 115 shown in the schematic view of FIG. 11 tend to be more readily generated. In the above-described configuration, as the print amount of white ink becomes larger, the print ratio of the reactive liquid 2 printed in the same print scan as that of color ink becomes higher, and the image quality is improved in consideration of even the influence on the thickness of the shielding layer.

In the above-described embodiment, a case where a total of eight print scans are performed has been explained. However, the number of print times can be adjusted in accordance with the print mode, and is not limited to eight. The pass masks of the reactive liquid 2 are those for 8-pass printing in the above example, but the reactive liquid 2 suffices to be printed in the same print scan as that of color ink. In this case, the pass masks of the reactive liquid 2 are not limited to those for 8-pass printing. In the above example, the print scans of the reactive liquid 2 suffice to overlap any of the fifth to eighth print scans in which color ink is printed. The pass masks can be properly adjusted so that the reactive liquid 2 is printed in print scans among the first to seventh print scans. When the pass masks of color ink are set in print scans other than the fifth to eighth print scans, those of the reactive liquid 2 are set so that the reactive liquid 2 is printed in the same passes as the print passes of color ink in, for example, the sixth to eighth print scans. The print amount of the reactive liquid 2 with respect to color ink can be adjusted by adjusting the frequency of print-permitted pixels of the pass mask in each pass.

As a dotted line 1002, 10b shows an example of the relationship of the distribution of the reactive liquid 2. A solid line 1001 in 10b represents the total print amount of the reactive liquid 2, and the dotted line 1002 represents the print amount of the reactive liquid 2 printed in the same print scan as that of color ink. The slope of the dotted line can be adjusted by changing the ratio of print-permitted pixels of the pass masks in the same print passes (fifth to eighth print scans in the above example) as those of color ink with respect to print-permitted pixels in the first to fourth print scans.

However, the cationic polymer-containing reactive liquid 2 exhibits a strong coagulation action on color ink. It is therefore preferable to adjust the total print amount of the reactive liquid 2 with respect to color ink as long as it does not affect degradation of the image quality of color ink.

As described above, according to the first embodiment, the print amount of reactive liquid is changed depending on whether the print target area is a stacking area or a non-stacking area. For example, pass masks assigned to the orifice array of the reactive liquid 2 used for white ink are adjusted for the stacking area shown in 7a, and the reactive liquid 2 is printed together with the reactive liquid 1 in the print area of color ink. This can suppress the above-mentioned generation of the precipitates 115 and effectively improve the color development of a printed product.

### Second Embodiment

In the second embodiment, control of the print amount of the reactive liquid 2 for a color ink layer 71 in a case where the stacking area is 7c and the non-stacking area is 7b will be explained. Note that the apparatus configuration (FIGS. 1A to 3), the compositions of inks and reactive liquids, and the preparation methods of the inks and reactive liquids are similar to those in the first embodiment, and a description thereof will not be repeated.

In the stacking area where the shielding layer is stacked on the color ink layer 71, print control is preferably performed so that the print amount of the reactive liquid 2 with respect to color ink becomes smaller than that in the non-stacking area formed from only the color ink layer 71. That is, control of decreasing the print amount of the reactive liquid 2 is performed in contrast to control of increasing the print amount of the reactive liquid 2 in the stacking area according to the first embodiment. This is because the surface of the color ink layer 71 in the stacking area is covered with a white ink layer 72 to suppress generation of precipitates such as metal salt crystals. Compared to the non-stacking area, the print amount of the reactive liquid 2 in the stacking area is preferably decreased in terms of the image quality and the like.

### <Operation of Apparatus>

FIG. 4B is a schematic view showing a printhead used in the second embodiment. Unlike the first embodiment (FIG. 4A), orifice arrays from which the reactive liquid 2 is discharged are two orifice arrays (orifice arrays 41R2a and 41R2b). The remaining orifice arrays are similar to those in the first embodiment, and a description thereof will not be repeated. Since the two orifice arrays are provided for the reactive liquid 2, the reactive liquid 2 for color ink and the reactive liquid 2 for white ink can be printed from the respective orifice arrays.

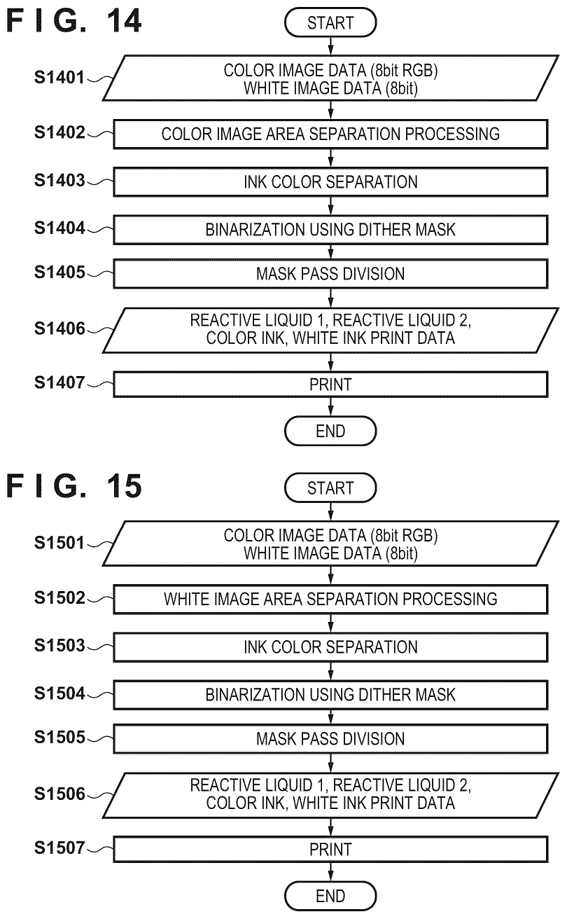

FIG. 14 is a flowchart showing image processing according to the second embodiment. Note that steps S1401, S1404, S1406, and S1407 are similar to steps S901, S903, S905, and S906 in the first embodiment, and a description thereof will not be repeated.

In step S1402, a control unit 20 performs area separation processing of color image data. The area separation processing of color image data is processing of separating color image data input in step S1401 into image data of a stacking area and that of a non-stacking area. As an example of the separation processing, each of color image data and white image data is binarized for a “print ON area” where ink printing is performed, and a “print OFF area” where no ink printing is performed. Then, the respective binarized image data are ANDed to obtain “stacking area binary data” representing a stacking area. The color image data and the stacking area binary data are ANDed to generate (separating) image data of the stacking area. In addition, the color image data and inverted data of the stacking area binary data are ANDed to generate image data of the non-stacking area. In this embodiment, the separation processing of image data into the stacking area and the non-stacking area is performed based on two image data input in step S1401, but the separation processing of image data is not limited to this. For example, color image data of the stacking area and non-stacking area may be separated in advance and input in step S1401, or the areas may be separated in processing in step S1403 and subsequent steps.

In step S1403, the control unit 20 performs ink color separation processing. Although this processing is basically similar to step S902 in the first embodiment, one RCT data is generated for the reactive liquid 1, whereas two RCT data are generated for the reactive liquid 2. That is, RCT data corresponding to the two orifice arrays 41R2a and 41R2b from which the reactive liquid 2 is discharged are generated. The RCT data corresponding to the orifice array 41R2a is generated based on the above-mentioned color stacking area image data and color non-stacking area image data. As the RCT data corresponding to the orifice array 41R2b, image data is generated based on the white image data.

10c and 10d are graphs showing examples of the print amount of reactive liquid according to the second embodiment. 10c shows the relationship of the print amount of the reactive liquid 1 in the orifice array 41R1 with respect to the print amount of color ink. 10d shows the relationship of the print amount of the reactive liquid 2 in the orifice array 41R2a with respect to the print amount of color ink. A solid line 1004 in 10d represents the print amount of the reactive liquid 2 with respect to the total print amount of color ink in the stacking area. A dotted line 1003 represents the print amount of the reactive liquid 2 with respect to the total print amount of color ink in the non-stacking area. As is understood from 10d, the print amount of the reactive liquid 2 in the stacking area is set to be smaller than that in the non-stacking area. RCT data for the orifice array 41R2a is generated by OR processing of RCT data respectively generated based on color stacking area image data and color non-stacking area image data.

In step S1405, the control unit 20 performs pass division on the binarized color ink data, white ink data, and RCT data. FIG. 12B is a view for explaining pass masks. FIG. 12B shows an example in which image printing of a unit area is performed by eight print scans, similar to the first embodiment.

The reactive liquid 2 for color ink is printed from the orifice array 41R2a in the first to fourth print scans (together with the reactive liquid 1 and color ink) on the upstream side in the conveyance direction. The reactive liquid 2 for white ink is printed from the orifice array 41R2b in a total of four, fifth to eighth print scans (together with white ink) on the downstream side in the conveyance direction. By these print steps, a stacked image in which a shielding layer of white ink is formed on the color ink layer 71 is printed. In color ink printing, the print amount of the reactive liquid 2 is controlled respectively for the stacking area and the non-stacking area in accordance with the relationship in 10d. The image quality characteristics are therefore improved in both the stacking area and the non-stacking area.

In the above explanation, the print amount of the reactive liquid 2 is determined based on the relationship shown in 10d in accordance with the print amount of color ink. However, as the shielding layer becomes thicker, precipitates tend to be less generated, as described above. From this, the print amount of the reactive liquid 2 can also be corrected in accordance with the thickness of the shielding layer (that is, the white ink print amount) with respect to the solid line 1004 in 10d. In this case, image data of the reactive liquid 2 generated in step S1403 based on color stacking area image data preferably undergoes correction processing based on the input value of white image data.

In the above explanation, the print amount of the reactive liquid 2 is determined based on the total print amount of color ink in the stacking area and the non-stacking area, but is not limited to this configuration. For example, the print amount of the reactive liquid 2 may be determined in consideration of even the hue or the like in addition to the total print amount of color ink.

As described above, according to the second embodiment, the print amount of reactive liquid is changed depending on whether the print target area is a stacking area or a non-stacking area. For example, the print amount of the reactive liquid 2 printed at the same time as printing of color ink in the stacking area shown in 7c is controlled to be smaller than that in the non-stacking area. Since the print amount of the reactive liquid 2 is restricted, the color development of a printed product can be improved.

Note that in the above-described first embodiment, the pass masks of the reactive liquid 2 are changed for the stacking structure in 7a in controlling the print amount of the reactive liquid 2 with respect to color ink. However, for the stacking structure in 7a, the print amount of the reactive liquid 2 may be controlled using the configuration described in the second embodiment (configuration having two orifice arrays for the reactive liquid 2). In this case, the relationship of the print amount of the reactive liquid 2 between the stacking area and the non-stacking area in 10d is changed so that the print amount of the reactive liquid 2 in the stacking area becomes larger than that in the non-stacking area. As for the pass masks of each orifice array, a group with which printing is performed in a total of four, first to fourth print scans on the upstream side in the conveyance direction in FIG. 12B, and a group with which printing is performed in a total of four, fifth to eighth print scans on the downstream side in the conveyance direction are interchanged. By this change, suitable print control can be adopted even for the stacking structure in 7a.

In the second embodiment, the configuration having two orifice arrays for the reactive liquid 2 has been exemplified, but a configuration having only one orifice array as shown in FIG. 4A is also possible. In this case, as for data having undergone ink color separation and binarization processing based on color stacking area image data, mask pass division is performed using pass masks with which printing is performed in the first to fourth print scans. In contrast, as for data having undergone ink color separation and binarization processing based on color non-stacking area image data, mask pass division is performed using pass masks with which printing is performed in the fifth to eighth print scans. These resultant data can be combined into print data of the orifice array (one array) of the reactive liquid 2. Even three or more arrays can be implemented by generating image data based on a color separation table corresponding to the number of orifice arrays in ink color separation in step S1403.

### Third Embodiment

In the above-described first and second embodiments, control of the print amount of the reactive liquid 2 for the color ink layer 71 in each of the stacking area and non-stacking area has been explained. In the third embodiment, control of the print amount of a reactive liquid 1 for a white ink layer 72 in a case where the stacking area is 7a and the non-stacking area is 7d will be explained. Note that the apparatus configuration (FIGS. 1A to 3), the compositions of inks and reactive liquids, and the preparation methods of the inks and reactive liquids are similar to those in the first embodiment, and a description thereof will not be repeated.

In the third embodiment, an effect of changing the print amount of the reactive liquid 1 with respect to white ink between the stacking area and the non-stacking area in a case where white ink is printed as a shielding layer on a print medium 12 and a color ink layer 71 is formed on the shielding layer will be explained.

As described above, a reactive liquid 2 is a reactive liquid mainly used for white ink, and coagulates white ink larger in color material content than color ink. Thus, the reactive liquid 2 has sufficient coagulation even when an image is formed by stacking color ink using the white ink layer 72 as a shielding layer. However, the reactive liquid 2 strongly coagulates ink, and thus the scratch resistance tends to readily decrease when white ink is not stacked on color ink, especially when the ink application amount is small.

The inventor of the present disclosure has found that when printing is performed without stacking white ink, particularly when the ink application amount is small, the scratch resistance of white ink could be improved by printing the reactive liquid 1 at the same time as the reactive liquid 2. In an area where color ink is stacked on white ink serving as a shielding layer, the amount of ink applied per area increases. It has been found out that even when the print amount of the reactive liquid 1 is smaller than that in the non-stacking area, the stacking area exhibits scratch resistance substantially equal to that in the non-stacking area.

When the coagulation of the white ink layer 72 is poor in the stacking area where color ink is printed on the white ink layer 72 serving as a shielding layer, the color ink printed on the white ink layer 72 may mix in the white ink to impair the color development. From the viewpoint of the coagulation of white ink, the print amount of the reactive liquid 1 in the stacking area is preferably decreased in comparison with the non-stacking area.

### <Operation of Apparatus>

FIG. 4C is a schematic view showing a printhead used in the third embodiment. Unlike the first and second embodiments, orifice arrays from which the reactive liquid 1 is discharged are two orifice arrays (orifice arrays 41R1a and 41R1b). The remaining orifice arrays are similar to those in the first and second embodiments, and a description thereof will not be repeated. Since the two orifice arrays are provided for the reactive liquid 1, printing can be performed from the respective orifice arrays of the reactive liquid 1 for print data for color ink and white ink.

FIG. 15 is a flowchart showing image processing according to the third embodiment. Note that steps S1501, S1504, S1506, and S1507 are similar to steps S901, S903, S905, and S906 in the first embodiment, and a description thereof will not be repeated.

In step S1502, a control unit 20 performs area separation processing of white image data. The area separation processing of white image data is processing of separating white image data input in step S1501 into image data of a stacking area and that of a non-stacking area. As an example of the separation processing, each of color image data and white image data is binarized for a “print ON area” where ink printing is performed, and a “print OFF area” where no ink printing is performed. Then, the respective binarized image data are ANDed to obtain “stacking area binary data” representing a stacking area. The white image data and the stacking area binary data are ANDed to generate (separating) image data of the stacking area. In addition, the white image data and inverted data of the stacking area binary data are ANDed to generate image data of the non-stacking area.

In step S1503, the control unit 20 performs ink color separation processing. Although this processing is basically similar to step S902 in the first embodiment, one RCT data is generated for the reactive liquid 2, whereas two RCT data are generated for the reactive liquid 1. That is, RCT data corresponding to the two orifice arrays 41R1a and 41R1b from which the reactive liquid 1 is discharged are generated. The RCT data corresponding to the orifice array 41R1a is generated based on the above-mentioned white stacking area image data and white non-stacking area image data. As the RCT data corresponding to the orifice array 41R1b, image data is generated based on the color image data.

10e and 10f are graphs showing examples of the print amount of reactive liquid according to the third embodiment. 10e shows the relationship of the print amount of the reactive liquid 1 in the orifice array 41R1a with respect to that of white ink. 10f shows the relationship of the print amount of the reactive liquid 2 in the orifice array 41R2 with respect to that of white ink. A solid line 1006 in 10e represents the print amount of the reactive liquid 1 with respect to the total print amount of white ink in the stacking area. A dotted line 1005 represents the print amount of the reactive liquid 1 with respect to the total print amount of white ink in the non-stacking area. As is understood from 10e, the print amount of the reactive liquid 1 in the stacking area is set to be smaller than that in the non-stacking area. Note that in an example described in this embodiment, the print amount of the reactive liquid 1 with respect to the total print amount of white ink in the stacking area is “0” regardless of the print amount of white ink. RCT data for the orifice array 41R1a is generated by OR processing of RCT data respectively generated based on white stacking area image data and white non-stacking area image data. Note that the print amount of the reactive liquid 1 printed for color ink is the same as that in the first embodiment.

In step S1505, the control unit 20 performs pass division on the binarized color ink data, white ink data, and RCT data. FIG. 12C is a view for explaining pass masks. FIG. 12C shows an example in which image printing of a unit area is performed by eight print scans, similar to the first embodiment. White ink is printed in a total of four, first to fourth print scans on the upstream side in the conveyance direction. Color ink is printed in a total of four, fifth to eighth print scans. By these print steps, an image in which color ink is stacked on the white ink layer 72 serving as a shielding layer is printed. In white ink printing, the print amount of the reactive liquid 1 is controlled respectively for the stacking area and the non-stacking area in accordance with the relationship in 10e. Thus, the color development in the white stacking area is improved.

As described above, according to the third embodiment, the print amount of reactive liquid is changed depending on whether the print target area is a stacking area or a non-stacking area. For example, the print amount of the reactive liquid 1 printed at the same time as printing of white ink in the stacking area shown in 7a is controlled to be smaller than that in the non-stacking area. Since the print amount of the reactive liquid 1 is restricted, an effect of suppressing degradation of color development in the stacking area can be obtained while maintaining scratch resistance in the non-stacking area.

Note that “control of the print amount of the reactive liquid 1 with respect to white ink printing” described in the third embodiment may be performed in combination with “control of the print amount of the reactive liquid 2 with respect to color ink printing” described in the first embodiment.

### Fourth Embodiment

In the fourth embodiment, control of the print amount of a reactive liquid 1 for a white ink layer 72 in a case where the stacking area is 7c and the non-stacking area is 7d will be explained. Note that the apparatus configuration (FIGS. 1A to 3), the compositions of inks and reactive liquids, and the preparation methods of the inks and reactive liquids are similar to those in the first embodiment, and a description thereof will not be repeated.

As described in the third embodiment, the scratch resistance of white ink in the non-stacking area can be improved by printing the reactive liquid 1 at the same time as a reactive liquid 2. Further, the scratch resistance of white ink in the stacking area can be improved by controlling the print amount of the reactive liquid 1 to be minimum. In the stacking area as shown in 7c, color ink and the reactive liquid have already been printed at a timing when white ink is printed. At this time, white ink can be coagulated by simultaneously printing the reactive liquid of a smaller amount than in the non-stacking area where white ink is printed on a print medium.

### <Operation of Apparatus>

The flowchart of image processing in the fourth embodiment is similar to that in the third embodiment (FIG. 15). However, a LUT different from that used in the third embodiment is used at the time of ink color separation in step S1503.

10g is a graph showing an example of the print amount of reactive liquid in an orifice array 41R1a. 10g shows the relationship of the reactive liquid 1 in the orifice array 41R1a with respect to white ink. A solid line 1008 in 10g represents the print amount of the reactive liquid 1 with respect to the total print amount of white ink in the stacking area. A dotted line 1007 represents the print amount of the reactive liquid 1 with respect to the non-stacking area. The relationship of the print amount represented by the dotted line 1007 is the same as the relationship of the print amount represented by the dotted line 1005 in 10e described above. To the contrary, the print amount of the reactive liquid 1 in the stacking area is set to be smaller than that in the non-stacking area.

In step S1505, an control unit 20 performs pass division on binarized color ink data, white ink data, and RCT data. FIG. 12D is a view for explaining pass masks. FIG. 12D shows an example in which image printing of a unit area is performed by eight print scans, similar to the second embodiment. Color ink is printed in a total of four, first to fourth print scans on the upstream side in the conveyance direction. White ink is printed in a total of four, fifth to eighth print scans. By these print steps, a stacked image in which a shielding layer of white ink is stacked on a color ink layer 71 is printed. In white ink printing, the print amount of the reactive liquid 1 is controlled respectively for the stacking area and the non-stacking area in accordance with the relationship in 10g. Hence, the scratch resistance in the white stacking area is improved.

Note that in the fourth embodiment, the configuration (FIG. 4B) having two orifice arrays for the reactive liquid 2 has been exemplified, but a configuration having only one orifice array as shown in FIG. 4A is also possible. In this case, separation processing of image data into the stacking area and the non-stacking area is performed, and data of one orifice array is generated after mask pass division, as described in the second embodiment.

In terms of the above-described scratch resistance and suppression of degradation of color development caused by the coagulation of the white ink layer 72, the print amount of the reactive liquid 1 with respect to white ink can also be controlled to differ between the stacking area shown in 7a and the stacking area shown in 7c.

10h shows the relationship of the reactive liquid 1 in the orifice array 41R1a with respect to white ink. A solid line 1010 in 10h represents the print amount of the reactive liquid 1 with respect to the total print amount of white ink in the stacking area. A dotted line 1009 represents the print amount of the reactive liquid 1 with respect to the non-stacking area. The relationship of the print amount represented by the dotted line 1009 is the same as that represented by the solid line 1008 in 10g. The relationship of the print amount represented by the solid line 1010 is the same as that represented by the solid line 1006 in 10e. The print amount of the reactive liquid 1 in the stacking area is set to be smaller than that in the non-stacking area.

As described above, according to the fourth embodiment, the print amount of reactive liquid is changed depending on whether the print target area is a stacking area or a non-stacking area. For example, the print amount of the reactive liquid 1 printed at the same time as printing of white ink in the stacking area shown in 7c is controlled to be smaller than that in the non-stacking area. Since the print amount of the reactive liquid 1 is restricted, an effect of suppressing degradation of color development in the stacking area can be obtained while maintaining scratch resistance in the non-stacking area.

Note that “control of the print amount of the reactive liquid 1 with respect to white ink printing” described in the fourth embodiment may be performed in combination with “control of the print amount of the reactive liquid 2 with respect to color ink printing” described in the second embodiment.

### Fifth Embodiment

Although a two-layered stacking area has been explained in the above-described first to fourth embodiments, the stacking structure is not limited to two layers. For example, the stacking structure may be a three-layered structure in which a white ink layer is an intermediate layer, and upper and lower layers are color ink layers, a four-layered structure in which color ink layers are intermediate layers, a five-layered structure, or the like.

In such a case, the print amount of a reactive liquid 2 for a color ink layer can be dealt with by the method described in the first and second embodiments. That is, for a color ink layer serving as the top layer (layer farthest from a print medium) of the stacking structure, the print amount of the reactive liquid 2 printed on the same print layer as color ink is controlled to be larger in the stacking area than that in the non-stacking area. For a color ink layer serving as an intermediate layer (layer not the top layer) of the stacking structure, the print amount of the reactive liquid 2 printed on the same print layer as color ink is controlled to be smaller in the stacking area than that in the non-stacking area.

To the contrary, the print amount of a reactive liquid 1 in a case where a white ink layer is printed can be dealt with by the third and fourth embodiments. That is, for a white ink layer serving as an intermediate layer of the stacking structure, the print amount of the reactive liquid 1 printed on the same print layer as white ink is controlled to be smaller in the stacking area than that in the non-stacking area. For a white ink layer serving as the top layer of the stacking structure, the print amount of the reactive liquid 1 printed on the same print layer as white ink is controlled to be smaller in the stacking area than that in the non-stacking area.

### (Modifications)

In the above-described embodiments, the inkjet printing apparatus has been explained by exemplifying a serial printer in which a printhead is moved together with a carriage, but may be a line head type printing apparatus in which a printhead is fixed. Even a printing apparatus of this type can obtain a printed product of similar image characteristics by controlling the print amounts of the reactive liquids 1 and 2 for a color ink layer and a white ink layer similarly to the above-described embodiments.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-122550, filed Jul. 29, 2024, which is hereby incorporated by reference herein in its entirety.

What is claimed is:

1. An inkjet printing apparatus comprising:
a printing unit configured to print an image on a print medium, the printing unit is configured to apply a first ink containing a color material, a second ink containing a color material of a type different from the first ink, a first reactive liquid that coagulates a color material in ink, and a second reactive liquid different from the first reactive liquid;
a generation unit configured to generate first print data by the first ink based on first image data, and generate second print data by the second ink based on second image data different from the first image data;
a determination unit configured to determine application amounts of the first ink, the second ink, the first reactive liquid, and the second reactive liquid for each partial area of the print medium based on the first print data and the second print data;
a conveyance unit configured to convey the print medium; and
a control unit configured to control the printing unit to drive the printing unit in synchronization with conveyance by the conveyance unit based on the application amounts determined by the determination unit,
wherein the determination unit determines the application amounts of the first reactive liquid and the second reactive liquid by a first determination method for a stacking area where a print image by the first ink and a print image by the second ink are stacked, and determines the application amounts of the first reactive liquid and the second reactive liquid by a second determination method different from the first determination method for a non-stacking area where the print image by the first ink and the print image by the second ink are not stacked.

2. The apparatus according to claim 1, wherein
the first ink is color ink,
the second ink is white ink,
the first reactive liquid contains at least a multivalent metal salt as a reactant component, and
the second reactive liquid contains at least a cationic polymer as the reactant component.

3. The apparatus according to claim 2, wherein the control unit controls the printing unit and the conveyance unit to apply the first ink after applying the second ink to the stacking area, and
the application amount of the second reactive liquid determined by the first determination method is larger than the application amount of the second reactive liquid determined by the second determination method with respect to the same application amount of the first ink.

4. The apparatus according to claim 3, wherein the control unit is configured to print an image on the print medium by performing a plurality of print scans in the same partial area, and
the control unit controls to apply at least part of the application amount of the second reactive liquid in the same print scan as a print scan of the first ink.

5. The apparatus according to claim 3, wherein the application amount of the first reactive liquid determined by the first determination method is smaller than the application amount of the first reactive liquid determined by the second determination method with respect to the same application amount of the first ink.

6. The apparatus according to claim 2, wherein the control unit controls the printing unit and the conveyance unit to apply the second ink after applying the first ink to the stacking area, and
the application amount of the second reactive liquid determined by the first determination method is smaller than the application amount of the second reactive liquid determined by the second determination method with respect to the same application amount of the first ink.

7. The apparatus according to claim 6, wherein the control unit is configured to print an image on the print medium by performing a plurality of print scans in the same partial area, and
the control unit controls to apply at least part of the application amount of the second reactive liquid in the same print scan as a print scan of the first ink.

8. The apparatus according to claim 2, wherein the control unit controls the printing unit and the conveyance unit to apply the first ink after applying the second ink to the stacking area, and
the application amount of the first reactive liquid determined by the first determination method is smaller than the application amount of the first reactive liquid determined by the second determination method with respect to the same application amount of the second ink.

9. The apparatus according to claim 2, wherein the control unit controls the printing unit and the conveyance unit to apply the second ink after applying the first ink to the stacking area, and
the application amount of the first reactive liquid determined by the first determination method is smaller than the application amount of the first reactive liquid determined by the second determination method with respect to the same application amount of the second ink.

10. The apparatus according to claim 8, wherein the control unit is configured to print an image on the print medium by performing a plurality of print scans in the same partial area, and
the control unit controls to apply at least part of the application amount of the first reactive liquid in the same print scan as a print scan of the second ink.

11. An information processing method comprising:
generating, based on first image data, first print data by a first ink containing a color material, and generating, based on second image data different from the first image data, second print data by a second ink containing a color material different from the first ink;
determining, for each partial area of a print medium based on the first print data and the second print data, application amounts of the first ink, the second ink, a first reactive liquid that coagulates a color material in ink, and a second reactive liquid different from the first reactive liquid; and
controlling a print scan by driving a printing unit in synchronization with conveyance of the print medium by a conveyance unit based on the application amounts determined in the determining,
wherein in the determining, the application amounts of the first reactive liquid and the second reactive liquid are determined by a first determination method for a stacking area where a print image by the first ink and a print image by the second ink are stacked, and the application amounts of the first reactive liquid and the second reactive liquid are determined by a second determination method different from the first determination method for a non-stacking area where the print image by the first ink and the print image by the second ink are not stacked.

12. A non-transitory computer-readable recording medium storing a program that, when executed by a computer, causes the computer to perform an information processing method comprising:
generating, based on first image data, first print data by a first ink containing a color material, and generating, based on second image data different from the first image data, second print data by a second ink containing a color material different from the first ink;
determining, for each partial area of a print medium based on the first print data and the second print data, application amounts of the first ink, the second ink, a first reactive liquid that coagulates a color material in ink, and a second reactive liquid different from the first reactive liquid; and
controlling a print scan by driving a printing unit in synchronization with conveyance of the print medium by a conveyance unit based on the application amounts determined in the determining,
wherein in the determining, the application amounts of the first reactive liquid and the second reactive liquid are determined by a first determination method for a stacking area where a print image by the first ink and a print image by the second ink are stacked, and the application amounts of the first reactive liquid and the second reactive liquid are determined by a second determination method different from the first determination method for a non-stacking area where the print image by the first ink and the print image by the second ink are not stacked.
